(19) United States
(12) Patent Application Publication
(10) Pub. No.: US 2014/0000763 A1
(43) Pub. Date: Jan. 2, 2014

(54) MAGNETIC MATERIAL

(71) Applicants: Kousaku Okamura, Shiga (JP); Kazuhiko Madokoro, Shiga (JP)

(72) Inventors: Kousaku Okamura, Shiga (JP); Kazuhiko Madokoro, Shiga (JP)

(73) Assignee: DAIHATSU MOTOR CO., LTD., Osaka (JP)

(21) Appl. No.: 14/004,804

(22) PCT Filed: Jan. 27, 2012
(86) PCT No.: PCT/JP2012/051863

§ 371 Date: Sep. 12, 2013

(30) Foreign Application Priority Data
Mar. 16, 2011 (JP) 2011-058580

(51) Int. Cl. H01F 1/01

(52) U.S. Cl. CPC H01F 1/01
USPC 148/302

(57) ABSTRACT

In a magnetic material, a magnet powder and an amorphous metal are used as ingredients. The magnet powder is neodymium-iron-boron magnet powder. The amorphous metal contains a rare-earth element, iron, and boron. The amorphous metal contains the rare-earth element in the range of 22 to 44 atomic %, and the boron in the range of 6 to 28 atomic %. The magnetic material is obtained by mixing the magnet powder and the amorphous metal, and heating the mixture to a temperature or more, the temperature being lower by 30° C. than the crystallization temperature (Tx) of the amorphous metal, or when the amorphous metal is a metallic glass, heating the mixture to a temperature of the glass transition temperature (Tg) thereof or more.

### TECHNICAL FIELD

The present invention relates to a magnetic material.

### BACKGROUND ART

Conventionally, as a magnet having high magnetic properties, for example, a nitrogen magnet (for example, a magnet having a Sm—Fe—N composition, etc.) has been proposed. However, although nitrogen magnet has a high potential and excellent magnetic properties, nitrogen magnet is thermally unstable, and when sintered, decomposition of nitrogen magnet component may reduce magnetic properties.

Therefore, for example, patent document 1 (see below) has proposed a nitrogen magnet, to be specific, a magnetic material obtained by mixing Sm₂Fe₁₇N₃ and metallic glass, to be specific, Nd₁₀Fe₁₀Al₁₀, and heating and pressurizing the mixture with a spark plasma sintering device.

With such a magnetic material, decomposition of nitrogen magnet is suppressed, and the gaps (voids) of the magnet powder are filled with metallic glass, and therefore a simple production reliably allows for excellent magnetic properties.

### CITATION LIST

### Patent Document

Patent Document 1: Japanese Unexamined Patent Publication No. 2011-23605

### SUMMARY OF THE INVENTION

### Problems to be Solved by the Invention

However, in those days, further improvement in various magnetic properties of magnetic materials has been required. An object of the present invention is to provide a magnetic material having excellent magnetic properties by simple production.

### Means for Solving the Problem

To achieve the above object, the magnetic material of the present invention is a magnetic material in which a magnet powder and an amorphous metal are used as ingredients,

wherein the magnet powder is a neodymium-iron-boron magnet powder,

the amorphous metal contains a rare-earth element, iron, and boron;

the amorphous metal contains the rare-earth element in the range of 22 to 44 atomic %, and the boron in the range of 6 to 28 atomic %; and

the magnetic material is obtained by mixing the magnet powder and the amorphous metal, and heating the mixture to a temperature or more, the temperature being lower by 30° C. than the crystallization temperature (Tx) of the amorphous metal, or when the amorphous metal is a metallic glass, heating the mixture to a temperature of the glass transition temperature (Tg) thereof or more.

In the magnetic material of the present invention, it is preferable that a magnetic anisotropic magnet powder is used as the magnet powder, and a mixture of the magnetic anisotropic magnet powder with the amorphous metal is subjected to magnetic field pressing.

### Effect of the Invention

The magnetic material of the present invention can be produced easily and can ensure excellent magnetic properties.

### Embodiment of the Invention

In a magnetic material of the present invention, a magnet powder and an amorphous metal are used as ingredients.

Examples of the magnet powder include a neodymium-iron-boron magnet powder.

The neodymium-iron-boron (in the following, sometimes referred to as Nd—Fe—B) magnet powder is a magnet powder that contains neodymium, iron, and boron, and has a Nd₂Fe₁₄B phase as a main phase; and without particular limitation, those having various composition percentages can be used.

In the Nd—Fe—B magnet powder, each of the elements may be partially replaced with another element.

To be specific, for example, Nd may be partially replaced with, for example, Dy (dysprosium), Tb (terbium), Pr (praseodymium), Y (yttrium), and Sm (samarium), and Fe may be partially replaced with, for example, Co (cobalt) and Ni (nickel). Furthermore, each of those elements may be replaced with, for example, Ga (gallium), Zr (zirconium), Hf (hafnium), Al (aluminum), Cu (copper), Mn (manganese), Ti (titanium), Si (silicon), Nb (niobium), V (vanadium), Cr (chromium), Ge (germanium), Mo (molybdenum), In (indium), Sn (tin), Ta (tantalum), W (tungsten), or Pb (lead).

The element may be replaced at a ratio without particular limitation, and the ratio can be set suitably in accordance with its purpose and use.

Such a Nd—Fe—B magnet powder can be obtained by a known method without particular limitation.

To be specific, for example, a microcrystalline Nd—Fe—B magnetic anisotropic magnet powder having a crystal grain size of 1 μm or less can be produced, for example, by producing a Nd—Fe—B alloy by rapid solidification processing, thereafter molding the Nd—Fe—B alloy into a block by hot isostatic pressing method (HIP method), then subjecting the obtained block to plastic working by a known method, and thereafter to grinding.

Or, for example, a Nd—Fe—B magnetic anisotropic magnet powder can be obtained, for example, by a method in which high temperature hydrogen processing that causes regular structural transformation is conducted by allowing the Nd—Fe—B alloy to occlude hydrogen while heating to 750 to 950° C., and then thereafter dehydrogenation processing is conducted by releasing the occluded hydrogen to cause reverse structural transformation (Hydrogenation Decomposition Desorption Recombination Method. Hereinafter referred to as HDDR Method).

The magnetic anisotropic magnet powder has a volume average particle size of, for example, 5 to 500 μm, preferably 10 to 300 μm.

When the magnetic anisotropic magnet powder has a volume average particle size within the above range, the packing factor of the magnetic powder improves, and excellent remanence can be ensured.

Examples of the Nd—Fe—B magnet powder also include a Nd—Fe—B nanocomposite magnet powder.

The Nd—Fe—B nanocomposite magnet powder is, for example, a powder of nanocomposite magnet having a Fe/Nd—Fe—B-based structure, and without particular limitation, for example, can be produced by, for example, quenching method.

To be more specific, in this method, for example, first, a molten ingredient alloy (Nd—Fe—B alloy) is quenched to produce a rapidly-solidified alloy. Then, the obtained rapidly-solidified alloy is heat-treated to disperse a hard magnetic phase and microcrystal of a soft magnetic phase. The Nd—Fe—B nanocomposite magnet powder is produced in this manner. The Nd—Fe—B nanocomposite magnet powder can be used, as necessary, by further grinding.

The Nd—Fe—B nanocomposite magnet powder can also be made, without limitation to the above-described method, by another known method.

Examples of the Nd—Fe—B based nanocomposite magnet powder include, to be more specific, a nanocomposite magnet powder of Fe and Nd₂Fe₁₄B (Curie point: 310° C.).

The nanocomposite magnet powder has a volume average particle size of, for example, 5 to 500 μm, preferably 10 to 300 μm.

When the nanocomposite magnet powder has a volume average particle size within the above range, the packing factor of the magnetic powder improves, and excellent remanence can be ensured.

Generally, when a microcrystalline magnet powder as described above is baked in the production of magnetic materials, its crystal undergoes coarsening, reducing the coercive force.

The microcrystalline magnet powder as described above undergoes coarsening at a temperature of, for example, 600° C. or more.

As the magnet powder, furthermore, a Nd—Fe—B magnet powder other than the above, to be specific, for example, a magnetic isotropic magnet powder, or a magnet powder having a crystal grain size of 1 μm or more, such as the one used as an ingredient for sintered magnet, can also be used.

These magnet powders may be used singly or in a combination of two or more.

As the magnet powder, preferably, a Nd—Fe—B magnet powder obtained by HDDR method, or a Nd—Fe—B nanocomposite magnet powder is used.

When the Nd—Fe—B magnet powder obtained by the HDDR method is used, improvement in coercive force and remanence can be achieved.

Furthermore, when the Nd—Fe—B nanocomposite magnet powder is used, for example, remanence can be improved.

In the present invention, the amorphous metal contains a rare-earth element, Fe (iron), and B (boron).

Such an amorphous metal contains the rare-earth element to cause crystal magnetic anisotropy in the baking, and to improve the magnetic properties (e.g., coercive force, etc.).

Examples of the rare-earth element include light rare-earth elements such as Sc (scandium), Y (yttrium), La (lanthanum), Ce (cerium), Pr (praseodymium), Nd (neodymium), Pm (promethium), Sm (samarium), and Eu (europium); and heavy rare-earth elements such as Gd (gadolinium), Tb (terbium), Dy (dysprosium), Ho (holmium), Er (erbium), Tm (thulium), Yb (ytterbium), and Lu (lutetium).

These rare-earth elements may be used singly or in a combination of two or more.

Although it is to be described later, such an amorphous metal can realize a sufficiently large coercive force after crystallization without necessarily containing a heavy rare-earth element.

As the rare-earth element, preferably, a light rare-earth element, and more preferably, Nd (neodymium), or Y (yttrium), and even more preferably, Nd (neodymium) is used.

When Nd (neodymium) is used as the rare-earth element, the coercive force and remanent magnetization of the magnetic material obtained by using the amorphous metal can be improved.

As the rare-earth element, preferably, Nd (neodymium) and Y (yttrium) are used in combination.

When the rare-earth element contains Nd (neodymium) and Y (yttrium), the coercive force and remanent magnetization of the magnetic material obtained by using the amorphous metal can be improved.

When the rare-earth element contains Nd (neodymium) and Y (yttrium), the Nd (neodymium) content is 65 to 95 atomic %, and the Y (yttrium) content is 5 to 35 atomic % relative to the total amount of Nd (neodymium) and Y (yttrium).

The amorphous metal has, in the range of 22 to 44 atomic %, preferably 23 to 40 atomic %, more preferably 24 to 37 atomic % of the rare-earth element (when used in combination, a total thereof).

When the rare-earth element atomic percent is below the above-described lower limit, the crystallization temperature (Tx) of the amorphous metal may become high, and therefore as described later, when the magnet powder and the amorphous metal are heat-treated to produce a magnetic material, there are disadvantages: the energy costs in the heat treatment increase, and furthermore, workability and productivity decrease.

When the rare-earth element atomic percent is below the above-described lower limit, there is a disadvantage in that the coercive force of the magnetic material decreases.

Meanwhile, when the rare-earth element atomic percent is more than the above-described upper limit, there is a disadvantage in that the remanent magnetization of the magnetic material decreases.

When the rare-earth element atomic percent is more than the above-described upper limit, there is a disadvantage in that the material is costly and easily oxidized, and therefore is less productive and safe.

In contrast, when the rare-earth element atomic percent is in the above-described range, the remanent magnetization and coercive force of the magnetic material obtained by using amorphous metal can be improved, and furthermore, the crystallization temperature (Tx) of the amorphous metal can be kept low. Therefore, as described later, without heat treatment at high temperature, a magnetic material can be produced at low costs, and with excellent workability and productivity.

In the amorphous metal, Fe (iron) is an element that contributes to magnetism, and is contained to improve magnetic properties (e.g., remanence, etc.) of the magnetic material.

The amorphous metal has an Fe (iron) atomic percent in the range of, for example, 15 to 65 atomic %, preferably 20 to 60 atomic %, more preferably 25 to 55 atomic %.

When the Fe (iron) atomic percent is below the above-described lower limit, the remanence after heat treatment (crystallization) described later of the magnetic material may be reduced.

When the Fe (iron) atomic percent is more than the above-described upper limit, the coercive force of the magnetic material after heat treatment (crystallization) described later may be reduced.

The amorphous metal contains B (boron) to form an amorphous phase, and to form an amorphous alloy.

The amorphous metal has a B (boron) atomic percent in the range of 6 to 28 atomic %, preferably 12 to 28 atomic %, more preferably 15 to 25 atomic %.

When the B (boron) atomic percent is below the above-described lower limit, at the time of quenching described later, a crystal phase may be generated, and in the case where a compact is produced using an amorphous metal as an ingredient by, for example, spark plasma sintering or hot pressing, moldability and processability may be reduced.

When the B (boron) atomic percent is more than the above-described upper limit, the remanence after heat treatment (crystallization) described later of the magnetic material may be reduced.

The amorphous metal preferably contains Co (cobalt).

The amorphous metal contains Co (cobalt) to improve magnetic properties of the magnetic material obtained by using an amorphous metal, and in an attempt to improve handleability by preventing oxidation.

Furthermore, when the amorphous metal is a metallic glass as described later, Co (cobalt) is contained to stabilize the metallic glass described later in the softened state (glass transition state), and to improve moldability.

The amorphous metal has a Co (cobalt) atomic percent in the range of, for example, 1 to 50 atomic %, preferably 2 to 45 atomic %, more preferably 4 to 40 atomic %.

When the Co (cobalt) atomic percent is below the above-described lower limit, handleability, moldability, and processability may be reduced.

In particular, when the amorphous metal is a metallic glass as described later, the supercooling region (region of glass transition temperature or more and below crystallization temperature. ΔTx(=Tx−Tg)) cannot be ensured sufficiently, and moldability and processability may be reduced.

When the Co (cobalt) atomic percent is more than the above-described upper limit, the remanence of the magnetic material obtained by using the amorphous metal may be reduced.

The atomic ratio of Co (cobalt) to Fe (iron) is preferably 1.5 or less, preferably 1.44 or less, and more preferably 0.6 or less.

When the atomic ratio of Co (cobalt) to Fe (iron) is 1.5 or less, handleability can be improved, and furthermore, when the atomic ratio of Co (cobalt) to Fe (iron) is 0.6 or less, a large coercive force can be realized by heat treatment. On the other hand, when the atomic ratio of Co (cobalt) to Fe (iron) is more than 1.5, there is a disadvantage in terms of costs.

The amorphous metal may further contain various other elements as additional elements, including, for example, transition elements such as Ti (titanium), Zr (zirconium), Hf (hafnium), V (vanadium), Nb (niobium), Ta (tantalum), Cr (chromium), Mo (molybdenum), W (tungsten), Mn (manganese), Ni (nickel), Cu (copper), Ru (ruthenium), Rh (rhodium), Pd (palladium), Ag (silver), Os (osmium), Ir (iridium), Pt (platinum), and Au (gold); and main group elements including, for example, C (carbon), P (phosphorus), Al (aluminum), Si (silicon), Ca (calcium), Ga (gallium), Ge (germanium), Sn (tin), Pb (lead), and Zn (zinc).

These additional elements may be used singly or in a combination of two or more.

Examples of preferable additional elements are Ti (titanium), Zr (zirconium), Nb (niobium), Cr (chromium), Ni (nickel), Cu (copper), Si (silicon), and Al (aluminum).

When at least one selected from the group consisting of Ti (titanium), Zr (zirconium), Nb (niobium), Cr (chromium), Ni (nickel), Cu (copper), Si (silicon), and Al (aluminum) is contained as the additional element, the remanence and coercive force of the magnetic material can be improved.

Such an amorphous metal has an additional element atomic percent of, for example, 1 to 15 atomic %, preferably 1 to 10 atomic %, more preferably 1 to 5 atomic %.

More preferable examples of the additional element are Al (aluminum) and Cu (copper).

When the amorphous metal contains Al (aluminum) and/or Cu (copper) as the additional element, the crystallization temperature (Tx) of the amorphous metal to be described later can be kept low, and therefore as described later, the magnetic material can be produced without performing heat treatment at high temperature, that is, at low costs, and with excellent workability and productivity.

When the amorphous metal is a metallic glass to be described later, the initial softening temperature (glass transition temperature (Tg)) of the metallic glass can be kept low, and therefore further improvement in moldability can be achieved.

In the case where the amorphous metal contains Al (aluminum) and/or Cu (copper), the Al (aluminum) atomic percent and/or the Cu (copper) atomic percent (when they are used in combination, their total) is, for example, below 15 atomic %, preferably below 5 atomic %, more preferably 3.5 atomic % or less, and more preferably 3 atomic % or less.

When the Al (aluminum) atomic percent is 5 atomic % or more, the crystallization temperature (Tx) of the amorphous metal becomes high, and may increase costs for magnetic material production, and may reduce workability and productivity.

When the amorphous metal contains Cu (copper) as the additional element, it can be regarded as metallic glass, and a wide range of supercooling region can be obtained.

The amorphous metal has a rare-earth element and Fe (iron)(also Co (cobalt) contained as necessary) atomic percent in total of, for example, 65 to 94 atomic %, preferably 70 to 90 atomic %, more preferably 72 to 85 atomic %.

When the rare-earth element and Fe (iron)(also Co (cobalt) contained as necessary) atomic percent in total is within the above-described range, moldability and processability of the amorphous metal can be improved, and furthermore, remanence and coercive force of the magnetic material after heat treatment (crystallization) described later can be made excellent.

The amorphous metal has an atomic percent in total of elements (the elements including B (boron) as an essential component, and including additional elements (e.g., Ti (titanium), Zr (zirconium), Nb (niobium), Cr (chromium), Ni (nickel), Cu (copper), Si (silicon), and Al (aluminum) as optional components) other than the rare-earth element and Fe (iron)(also Co (cobalt) contained as necessary) of, for example, in the range of 6 atomic % or more, preferably 10 to 30 atomic %, more preferably 15 to 28 atomic %, particularly preferably 15 to 25 atomic %.

When the atomic percent in total of the elements other than the rare-earth element, Fe (iron), and Co (cobalt) is within the above-described range, moldability and processability of the amorphous metal can be improved, and furthermore, the remanence and coercive force of the magnetic material after heat treatment (crystallization) described later can be made excellent.

Furthermore, such an amorphous metal allows deposition of a hard magnetic phase at low temperature, and without necessarily containing a heavy rare-earth element, a sufficiently large coercive force can be realized.

An example of an embodiment of such an amorphous metal include an amorphous metal represented by formula (1) below.

R₈₃₋ₛFe_{x/2}Co_{x/2}Al_{17-y}B_{y} (1)

(where R represents a rare-earth element, 0<x<83, and 0<y<17.)

In formula (1) above, R represents the above-described rare-earth element (the same applies to the following).

The range of x is 0<x<83, preferably 28<x<58, and more preferably 33<x<53.

When the value of x is within the above-described range, moldability and processability of the amorphous metal can be improved, and furthermore, the remanence and coercive force of the magnetic material after heat treatment (crystallization) described later can be made excellent.

The range of y is 0<y<17, preferably 12<y<17, and more preferably 13.5<y<17.

When the value of y is within the above-described range, moldability and processability of the amorphous metal can be improved, and furthermore, the remanence and coercive force of the magnetic material after heat treatment (crystallization) described later can be made excellent.

Such an amorphous metal is not particularly limited, and can be produced by a known method.

To be more specific, for example, first, powder, or block (as necessary, may be partially alloyed) of the above-described elements is prepared as an ingredient component, and these are mixed to have the above-described atomic percent.

Then, the obtained mixture of the ingredient components are melted under an atmosphere of inert gas (e.g., nitrogen gas, argon gas, etc.).

The method for melting the ingredient components is not particularly limited, as long as the above-described elements can be melted, and for example, arc melting can be used.

Then, for example, the ingredient components are cooled, thereby producing a block alloy (ingot) containing the above-described elements at the above-described atomic percent. Thereafter, the obtained block alloy is ground by a known method, thereby producing a particulate alloy (particle size: 0.5 to 20 mm)

Thereafter, in this method, the obtained particulate alloy is melted, thereby producing a molten alloy.

The method for melting the particulate alloy is not particularly limited, as long as the above-described particulate alloy can be melted, and for example, high-frequency induction heating can be used.

Next, in this method, the obtained molten alloy is quenched by a known method, for example, by single roll method, or gas atomizing process, thereby producing an amorphous metal.

In the single roll method, for example, the molten alloy is allowed to fall on the peripheral surface of the revolving chill roll, and the molten alloy and the chill roll are brought into contact for a predetermined time period, thereby quenching the molten alloy.

The molten alloy is quenched at a rate (cooling speed) of, for example, 10⁻² to 10³° C./s.

The rate of the quenching (cooling speed) of the molten alloy can be controlled, for example, by adjusting the revolving speed of the chill roll. In such a case, the revolving speed of the chill roll is, for example, 1 to 60 m/s, preferably 20 to 50 m/s, more preferably 30 to 40 m/s.

By quenching the molten alloy in such a manner, for example, a belt-form (including a thin film and a thick film) amorphous metal can be obtained on the peripheral surface of the chill roll.

The obtained amorphous metal has a thickness of, for example, 1 to 500 μm, preferably 5 to 300 μm, more preferably 10 to 100 μm.

In the gas atomizing process, for example, a high-pressure gas (e.g., helium gas, argon gas, nitrogen gas, etc.) spray is applied over to the molten alloy to quench and at the same time finely grinding the above-described molten alloy.

By quenching the molten alloy in this manner, a powdered amorphous metal can be obtained.

The obtained amorphous metal has a volume average particle size of, for example, 1 to 200 μm, preferably 5 to 50 μm.

The method for quenching the molten alloy is not limited to the above-described single roll method and the gas atomizing process, and a known method can be applied. Preferably, the single roll method is used.

The crystallization temperature (Tx) of the amorphous metal (temperature at which crystallization is started) is, for example, 600° C. or less, preferably 550° C. or less, more preferably 500° C. or less.

The crystallization temperature (Tx) of the amorphous metal can be measured by DSC (differential scanning calorimetry), and in the present invention, the crystallization temperature (Tx) is defined as a value measured at a rate of temperature increase of 40° C./min

When a plurality of the crystallization temperatures (Tx) are observed, the lowest crystallization temperature (Tx) of the crystallization temperatures (Tx) obtained is regarded as the crystallization temperature (Tx) of the amorphous metal.

The thus obtained amorphous metal contains metallic glass.

The metallic glass is an amorphous alloy having a glass transition temperature (Tg) of below the crystallization temperature (Tx), and has high moldability.

When the thus obtained amorphous metal is metallic glass, the initial softening temperature (glass transition temperature (Tg)) is, for example, 600° C. or less, preferably 500° C. or less, more preferably 450° C. or less.

The amorphous metal may be softened by heating even if the amorphous metal is not metallic glass, and in such a case, the initial softening temperature is, for example, 600° C. or less, preferably 500° C. or less, more preferably 450° C. or less.

The initial softening temperature of the amorphous metal (including metallic glass) can be measured, for example, by DSC (differential scanning calorimetry) or by press displacement measurement of a spark plasma sintering device.

These amorphous metals may be used singly or in a combination of two or more.

In the present invention, to produce the magnetic material, first, the magnet powder and the amorphous metal are mixed.

The mixing ratio of the magnet powder and the amorphous metal relative to 100 parts by mass of the total of the magnet powder and the amorphous metal is as follows: for example, 60 to 99 parts by mass, preferably, 80 to 95 parts by mass of the magnet powder; and for example, 1 to 40 parts by mass, preferably 5 to 20 parts by mass of the amorphous metal.

The mixing is not particularly limited, as long as the magnet powder and the amorphous metal are sufficiently mixed, and for example, a known mixer such as a ball mill may be used.

In this method, any of the dry mixing, and wet mixing may be used. For example, in dry mixing, the magnet powder and the amorphous metal are mixed under an inert gas (e.g., nitrogen gas, argon gas, etc.) atmosphere. In wet mixing, the magnet powder and the amorphous metal are mixed in a solvent (e.g., cyclohexane, acetone, ethanol, etc.).

The mixing conditions are not particularly limited, and when a ball mill (content 0.3L) is used, the number of revolution is, for example, 100 to 300 rpm, preferably 150 to 250 rpm, and the mixing time is, for example, 5 to 60 min, preferably 5 to 45 min

Next, in this method, a mixture of the magnet powder and the amorphous metal is heated, for example, while applying pressure, to a temperature or more, the temperature being lower than the crystallization temperature (Tx) of the amorphous metal by 30° C.

When the amorphous metal is metallic glass, a mixture of the magnet powder and the amorphous metal can also be heated, for example, while applying pressure, to a temperature of the glass transition temperature (Tg) thereof or more.

To be more specific, in this method, for example, by using a hot pressing device or spark plasma sintering device, a mixture of the magnet powder and the amorphous metal is heated, for example, under a pressure condition of, 20 to 1500 MPa, preferably 200 to 1000 MPa, to a temperature or more, the temperature being lower than the crystallization temperature (Tx) of the amorphous metal by 30° C.; or when the amorphous metal is metallic glass, to its glass transition temperature (Tg) or more, preferably the crystallization temperature (Tx) of the amorphous metal or more, to be specific, for example, 400 to 600° C., preferably 410 to 550° C.

With such a molding under pressure and heat, the amorphous metal is deformed, and in this manner, a high density magnetic material can be obtained. Furthermore, the amorphous metal is a hard magnetic phase, and therefore a magnetic material containing a magnet powder and a hard magnetic phase generated from the amorphous metal can be obtained.

The heating is not particularly limited, and for example, can be performed at a predetermined rate of temperature increase from normal temperature. In such a case, the rate of temperature increase is, for example, 10 to 200° C./min, preferably 20 to 100° C./min

In the production of a magnetic material, as necessary, by using, for example, an image furnace, after the above-described molding under pressure and heat, the compact of a magnet powder, and the amorphous metal or a hard magnetic phase generated from the amorphous metal can also be kept for a predetermined time period under a high temperature condition.

In such a case, after the above-described heat treatment, the compact can be kept, for example, at 400 to 600° C., preferably 410 to 550° C., for example, for 1 to 120 min, preferably, 10 to 60 min

In this manner, the crystallization heat treatment process of the amorphous metal can be performed in batches, and therefore productivity of magnetic materials can be improved.

Furthermore, in the production of a magnetic material, after the temperature increase in molding under pressure and heat, as necessary, the compact can be kept under pressure and heat.

Furthermore, in the production of a magnetic material, for example, the above-described molding under pressure and heat, and heat treatment thereafter can be performed in a magnetic field.

Also, as a pretreatment for the above-described molding under pressure and heat, a pressure may be applied to a mixture of the magnet powder and the amorphous metal in the magnetic field (magnetic field pressing).

In particular, when a magnetic anisotropic magnet powder is used as the magnet powder, preferably, a mixture of the magnet powder and the amorphous metal is subjected to the magnetic field pressing.

When a pressure is applied in the magnetic field, the magnet powder can be orientated toward a predetermined direction, and therefore magnetic properties of the obtained magnetic material can be further improved.

The conditions for the magnetic field pressing are, for example, as follows: a magnetic field to be applied of 10 kOe or more, preferably 20 kOe or more; and a pressure of, for example, 30 to 2000 MPa, preferably 100 to 1000 MPa.

The thus obtained magnetic material has a compact density (bulk density) of, for example, 6 to 7.5 g/cm³, preferably 6.5 to 7.5 g/cm³.

When the compact density is within the above range, excellent magnetic flux density can be achieved.

The compact density can be calculated, for example, by Archimedes' principle, or for example, formula (2) below.

ρ=m/V (2)

(where ρ represents the density (compact density) of the magnetic material, m represents the mass of the magnetic material, and V represents the volume of the magnetic material.)

With the thus obtained magnetic material, material deterioration caused by baking of the magnet powder, to be more specific, coarsening of the crystal is suppressed, and also gaps (voids) of the magnet powder is filled with the hard magnetic phase produced from the amorphous metal having excellent magnetic properties.

Thus, with such a magnetic material, excellent magnetic properties can be ensured with simple production.

In such a magnetic material, the amorphous metal has a rare-earth element atomic percent in the range of 22 to 44 atomic %, and thus the crystallization temperature (Tx) is kept low: therefore, a magnetic material can be produced without heat treatment at high temperature, that is, at low costs, and with excellent workability and productivity. Furthermore, because the hard magnetic phase produced from the amorphous metal has excellent magnetic properties, a magnetic material having excellent magnetic properties can be produced.

That is, an amorphous metal (e.g., Nd₆₀Fe₃₀Al₁₀, etc.) excluding the above-described composition can be used as the amorphous metal, but such an amorphous metal has insufficient magnetic properties, and therefore magnetic properties of the obtained magnetic material may be poor.

On the other hand, the magnetic material of the present invention is produced by mixing the above-described amorphous metal and the magnet powder, and heating the mixture to a temperature of the initial deformation temperature or more of the amorphous metal, and therefore excellent magnetic properties can be achieved.

### EXAMPLES

In the following, the present invention will be described based on Examples and Comparative Examples, but the present invention is not limited to Examples below.

### Production Examples 1 to 6

### (Production of Amorphous Metal)

Elements of Nd (neodymium), Fe (iron), Co (cobalt), B (boron), and Cu (copper) in the form of powder or block are formulated in accordance with the mixing ratio shown in Table 1, and melted using an arc melting furnace under an atmosphere of Ar (argon) at −4 kPa (−30 Torr), thereby producing alloys (ingot) having composition percentage shown in Table 1.

Then, the obtained ingot was ground, thereby producing a particulate alloy (particle size: 0.5 to 10 mm)

Thereafter, the obtained particulate alloy was melted by high frequency induction heating to produce a molten alloy, and then the obtained molten alloy was quenched under an atmosphere of Ar by allowing the obtained molten alloy to fall on the peripheral surface of a chill roll of a revolving speed of 40 m/s using a single roll device. The amorphous metal was obtained in this manner.

Thereafter, the obtained amorphous metal was finely ground using a planetary ball mill (LP-1 manufactured by Ito Seisakusho Co., Ltd.) or a mortar. The grounding with the planetary ball mill gives powder with a volume average particle size of 1.5 μm, and with the mortar, powder with a volume average particle size of 20 μm was obtained.

### Production of Production Example 7

### (Production of Amorphous Metal)

Nd₆₀Fe₃₀Al₁₀was produced by gas atomizing process (spraying gas: Ar), and then finely ground by ball mill (manufactured by Ito Seisakusho Co., Ltd. LP-1) thereafter. Nd₆₀Fe₃₀Al₁₀ powder having a volume average particle size of 1 μm was obtained in this manner.

### [Evaluation]

Using a DSC (differential scanning calorimetry: manufactured by SII Inc., DSC6300), the crystallization temperature (Tx) of the amorphous metal obtained in Production Examples, and when the amorphous metal was metallic glass, the glass transition temperature (Tg) were measured.

To be specific, 10 mg of an amorphous metal sample was introduced into an alumina pan, and measured under an Ar atmosphere at a rate of temperature increase of 40° C./min.

When a plurality of crystallization reactions (Tx) were observed, the lower of the temperatures was regarded as the crystallization temperature (Tx).

When the crystallization temperature (Tx) and the glass transition temperature (Tg) were observed, the supercooling region ΔTx (=Tx−Tg) was calculated.

The results are shown in Table 1.

TABLE 1

| | | | | | | | | Evaluation | | |
|---|---|---|---|---|---|---|---|---|---|---|
| Production | Blending Formulation | | | | | | | Glass Transition | Crystallization | Supercooling |
| Example | (Atomic %) | | | | | | | Temperature | Temperature | Region |
| No. | Nd | Fe | Co | B | Cu | Al | Co/Fe | Tg (° C.) | Tx (° C.) | [symbol] Tx (° C.) |
| Production | 35.6 | 43.1 | 4.3 | 17.0 | — | — | 0.1 | 433 | 448 | 15 |
| Example 1 | | | | | | | | | | |
| Production | 34.3 | 41.6 | 4.2 | 20.0 | — | — | 0.1 | 431 | 447 | 16 |
| Example 2 | | | | | | | | | | |
| Production | 33.0 | 44.0 | 0.0 | 23.0 | — | — | 0.0 | 441 | 465 | 24 |
| Example 3 | | | | | | | | | | |
| Production | 32.0 | 40.0 | 4.0 | 23.0 | 1.0 | — | 0.1 | 437 | 452 | 15 |
| Example 4 | | | | | | | | | | |
| Production | 30.0 | 40.0 | 4.0 | 23.0 | 3.0 | — | 0.1 | 420 | 465 | 45 |
| Example 5 | | | | | | | | | | |
| Production | 30.9 | 37.4 | 3.7 | 28.0 | — | — | 0.1 | — | 450 | — |
| Example 6 | | | | | | | | | | |
| Production | 60.0 | 30.0 | — | — | — | 10.0 | — | — | 506 | — |
| Example 7 | | | | | | | | | | |

### Examples 1 to 9 and Comparative Examples 1 to 2

The amorphous metal powder obtained in Production Example 1, and MFP-19 (trade name, Nd—Fe—B magnetic anisotropic magnet powder produced by HDDR method, manufactured by Aichi Steel Corporation) were mixed in a ratio shown in Table 2 in a mortar, thereby producing a powder mixture of the amorphous metal powder and the magnet powder.

Thereafter, 0.3 g of the powder mixture was taken out, and charged in a cemented carbide mold (molding size: 5 mm×5 mm) The powder mixture was heated (increased temperature) at a rate of temperature increase of 40° C./min under vacuum under a pressure shown in Table 2 to the temperature shown in Table 2 using a spark plasma sintering device (SPS-515S manufactured by SPS Sintex Inc.), and kept for the time shown in Table 2. The magnetic material was obtained in this manner.

In Examples 8 and 9, the magnetic material taken out from the spark plasma sintering device was heat-treated in an image furnace in vacuum at 460° C. for 25 min

In Comparative Example 1, a magnetic material was produced without blending the amorphous metal.

In Comparative Example 2, the heating was conducted to a temperature lower than the glass transition temperature (433° C.) of the amorphous metal by 13° C., i.e., to a temperature of (420° C.).

The density (compact density) of the obtained magnetic materials was calculated by formula (2) below.

ρ=m/V (2)

(where ρ represents the density of the magnetic material (compact density), m represents the mass of the magnetic material, and V represents the volume of the magnetic material.)

The results are shown in Table 2.

TABLE 2

| | Mixing Ratio (parts by mass) | | | | | |
|---|---|---|---|---|---|---|
| Example and | | Amorphous Metal | Spark Plasma Sintering | | | |
| Comparative | | Production Example 1 | Conditions | | | |
| Example | Magnet Powder | (Crystallization | Pressure | Temperature | Time | |
| No. | MFP-19 | Temperature: 448° C.) | (MPa) | (° C.) | (min) | Density (g/cm³) |
| Example 1 | 95 | 5 | 600 | 460 | 30 | 7.24 |
| Example 2 | 80 | 20 | 600 | 460 | 30 | 7.35 |
| Example 3 | 90 | 10 | 600 | 460 | 30 | 7.43 |
| Example 4 | 85 | 15 | 600 | 460 | 30 | 7.36 |
| Example 5 | 90 | 10 | 600 | 460 | 10 | 6.82 |
| Example 6 | 90 | 10 | 600 | 440 | 30 | 6.81 |
| Example 7 | 90 | 10 | 800 | 440 | 30 | 7.26 |
| Example 8 | 90 | 10 | 800 | 440 | 5 | 6.93 |
| Example 9 | 90 | 10 | 800 | 460 | 5 | 7.12 |
| Comparative | 100 | 0 | 600 | 460 | 30 | 6.93 |
| Example 1 | | | | | | |
| Comparative | 90 | 10 | 600 | 420 | 30 | 6.71 |
| Example 2 | | | | | | |

### Examples 10 to 22 and Comparative Examples 3 to 4

The amorphous metal powder produced in Production Example 2 was blended and mixed with MFP-15 (trade name, Nd—Fe—B magnetic anisotropic magnet powder obtained by HDDR method, Aichi Steel Corporation) in a mortar at ratios shown in Table 3, thereby producing a powder mixture of the amorphous metal powder and the magnet powder.

Thereafter, 0.3 g of the powder mixture was taken out, and charged in a cemented carbide mold (molding size: 5 mm×5 mm) The powder mixture was heated (increased temperature) under vacuum under a pressure shown in Table 3 to the temperature shown in Table 3 using a spark plasma sintering device (SPS-515S manufactured by SPS Sintex Inc.), and kept at the temperature for the time shown in Table 3, and then thereafter cooled. The magnetic material was obtained in this manner.

In Comparative Example 3, the magnetic material was produced without blending the amorphous metal.

In Comparative Example 4, the heating was conducted to a temperature lower than the glass transition temperature (431° C.) of the amorphous metal by 11° C., i.e., (420° C.).

The density (compact density) of the obtained magnetic materials was calculated by formula (2) above. The results are shown in Table 3.

TABLE 3

| Example | Mixing Ratio (parts by mass) | | | | | |
|---|---|---|---|---|---|---|
| and | | Amorphous Metal | Spark Plasma Sintering | | | |
| Comparative | | Production Example 2 | Conditions | | | |
| Example | Magnet Powder | (Crystallization | Pressure | Temperature | Time | Density |
| No. | MFP-15 | Temperature: 447° C.) | (MPa) | (° C.) | (min) | (g/cm³) |
| Example 10 | 90 | 10 | 600 | 480 | 30 | 7.31 |
| Example 11 | 90 | 10 | 200 | 480 | 30 | 6.87 |
| Example 12 | 90 | 10 | 400 | 480 | 30 | 7.35 |
| Example 13 | 90 | 10 | 800 | 480 | 30 | 7.44 |
| Example 14 | 90 | 10 | 600 | 440 | 30 | 7.22 |
| Example 15 | 90 | 10 | 600 | 460 | 30 | 7.30 |
| Example 16 | 90 | 10 | 600 | 500 | 30 | 7.46 |
| Example 17 | 90 | 10 | 600 | 480 | 10 | 7.47 |
| Example 18 | 90 | 10 | 600 | 480 | 60 | 7.42 |
| Example 19 | 90 | 10 | 600 | 480 | 90 | 7.49 |
| Example 20 | 60 | 40 | 600 | 480 | 30 | 7.44 |
| Example 21 | 70 | 30 | 600 | 480 | 30 | 7.42 |
| Example 22 | 80 | 20 | 600 | 480 | 30 | 7.48 |
| Comparative | 100 | 0 | 600 | 480 | 30 | 7.11 |
| Example 3 | | | | | | |
| Comparative | 90 | 10 | 600 | 420 | 30 | 6.83 |
| Example 4 | | | | | | |

### Examples 23 to 29

The amorphous metal powders produced in Production Examples 3 to 6 were mixed with MFP-15 or MFP-19 at ratios shown in Table 4 in a mortar, thereby producing a powder mixture of the amorphous metal powder and the magnet powder.

Thereafter, 0.3 g of the powder mixture was taken out, and charged in a cemented carbide mold (molding size: 5 mm×5 mm) The powder mixture was heated (increased temperature) under vacuum under a pressure shown in Table 4 to the temperature shown in Table 4 using a spark plasma sintering device (SPS-515S manufactured by SPS Sintex Inc.), and kept at the temperature for the time shown in Table 4, and then thereafter cooled. The magnetic material was obtained in this manner.

The density (compact density) of the obtained magnetic materials was calculated based on formula (2) above. The results are shown in Table 4.

TABLE 4

| | Mixing Ratio (parts by mass) | | | | | | | | | |
|---|---|---|---|---|---|---|---|---|---|---|
| | | | Amorphous Metal | | | | | | | |
| | | | Production | Production | Production | Production | | | | |
| | | | Example 3 | Example 4 | Example 5 | Example 6 | Spark Plasma | | | |
| | Magnet Powder | | (Crystallization | (Crystallization | (Crystallization | (Crystallization | Sintering Conditions | | | |
| Example | MFP- | MFP- | Temperature: | Temperature: | Temperature: | Temperature: | Pressure | Temperature | Time | Density |
| No. | 15 | 19 | 465° C.) | 452° C.) | 465° C.) | 450° C.) | (MPa) | (° C.) | (min) | (g/cm³) |
| Example | 90 | — | 10 | — | — | — | 600 | 460 | 30 | 7.07 |
| 23 | | | | | | | | | | |
| Example | 90 | — | — | 10 | — | — | 600 | 460 | 30 | 7.39 |
| 24 | | | | | | | | | | |
| Example | 90 | — | — | — | 10 | — | 600 | 480 | 30 | 7.33 |
| 25 | | | | | | | | | | |
| Example | — | 90 | 10 | — | — | — | 600 | 460 | 30 | 7.16 |
| 26 | | | | | | | | | | |
| Example | — | 90 | — | 10 | — | — | 600 | 460 | 30 | 7.21 |
| 27 | | | | | | | | | | |
| Example | 90 | — | — | — | — | 10 | 600 | 460 | 30 | 7.23 |
| 28 | | | | | | | | | | |
| Example | 90 | — | — | — | — | 10 | 600 | 420 | 30 | 6.85 |
| 29 | | | | | | | | | | |

### Comparative Example 5

The Nd₆₀Fe₃₀Al₁₀ powder obtained in Production Example 7 was blended with Z16 (magnet powder, Sm—Fe—N magnet (Sm₂Fe₁₇N₃), decomposition temperature 600° C., volume average particle size 3 μm, manufactured by Nichia Corporation) so that Nd₆₀Fe₃₀Al₁₀ was 10 mass % relative to the total of the Nd₆₀Fe₃₀Al₁₀ powder and Z16, and they were mixed under a nitrogen atmosphere in a ball mill (manufactured by Ito Seisakusho Co., Ltd., LP-1 content 0.3L), at 250 rpm for 30 min.

Thereafter, 0.5 g of the obtained mixture of Nd₆₀Fe₃₀Al₁₀ and Z16 was taken out, and charged in a mold (size: 5 mm×5 mm, cemented carbide mold). A pressure of 800 MPa was applied to the mixture using a spark plasma sintering device (manufactured by SPS Sintex Inc.), and at the same time, the mixture was heated (increased temperature) for 10 min to 420° C., and thereafter cooled. The magnetic material was obtained in this manner.

### Example 30 and Comparative Example 6

The amorphous metal powder produced in Production Example 2 was blended and mixed with MFP-15 (trade name, Nd—Fe—B magnetic anisotropic magnet powder obtained by HDDR method, Aichi Steel Corporation)) at ratios shown in Table 5 in a mortar, thereby producing a powder mixture of the amorphous metal powder and the magnet powder.

Thereafter, 2.0 g of the powder mixture was taken out, and charged in a nonmagnetic mold (manufactured by Hokkai M.I.C., molding size : 8 mm×6 mm), and subjected to magnetic field pressing using a magnetic field pressing device (model TM-MPH8525-10T manufactured by Tamakawa Co., Ltd.), with a magnetic field of 25 kOe, at a pressing pressure of 800 MPa.

Thereafter, the powder mixture was heated (increased temperature) under vacuum under a pressure shown in Table 5 to the temperature shown in Table 5 using a spark plasma sintering device (SPS-515S manufactured by SPS Sintex Inc.), and kept at the temperature for the time shown in Table 5, and then thereafter cooled. The magnetic material was obtained in this manner.

In Comparative Example 6, the magnetic material was produced without blending the amorphous metal.

TABLE 5

| Example | Mixing Ratio (parts by mass) | | | | | |
|---|---|---|---|---|---|---|
| and | | Amorphous Metal | Spark Plasma Sintering | | | Magnetic Field |
| Comparative | | Production Example 2 | Conditions | | | Pressing Pressure |
| Example | Magnet Powder | (Crystallization | Pressure | Temperature | Time | Conditions |
| No. | MFP-15 | Temperature: 447° C.) | (MPa) | (° C.) | (min) | (MPa) |
| Example 30 | 90 | 10 | 600 | 500 | 30 | 800 |
| Comparative | 100 | 0 | 600 | 500 | 30 | 800 |
| Example 6 | | | | | | |

Evaluation

Magnetic materials obtained in Examples and Comparative Examples (excluding Example 30 and Comparative Example 6) were measured for demagnetization curve using VSM (manufactured by Tamakawa Co., Ltd.), and their magnetic properties were evaluated. The results are shown in Tables 6 to 8.

TABLE 6

| Example | | | | | |
|---|---|---|---|---|---|
| and | | | | | |
| Comparative | Maximum | | B Coercive | I Coercive | Maximum Energy |
| Example | magnetization | Remanence | Force | Force | Product |
| No. | Jmax (T) | Br (T) | bHc (kA/m) | iHc (kA/m) | (BH)max (kJ/m³) |
| Example 1 | 0.9658 | 0.6238 | 387.4 | 878.5 | 62.45 |
| Example 2 | 0.8977 | 0.5904 | 409.4 | 1378.0 | 61.73 |
| Example 3 | 0.9617 | 0.6304 | 410.8 | 1084.0 | 66.29 |
| Example 4 | 0.9198 | 0.6040 | 399.8 | 1126.0 | 61.41 |
| Example 5 | 0.8853 | 0.5719 | 358.7 | 901.3 | 52.51 |
| Example 6 | 0.8875 | 0.5765 | 362.5 | 902.8 | 53.66 |
| Example 7 | 0.9293 | 0.5983 | 366.5 | 825.3 | 56.41 |
| Example 8 | 0.8833 | 0.5671 | 344.6 | 1070.0 | 50.64 |
| Example 9 | 0.9223 | 0.5882 | 352.1 | 948.6 | 53.35 |
| Comparative | 0.9749 | 0.6240 | 373.9 | 837.3 | 60.26 |
| Example 1 | | | | | |
| Comparative | 0.8695 | 0.5553 | 339.5 | 886.5 | 48.41 |
| Example 2 | | | | | |

TABLE 7

| Example | | | | | |
|---|---|---|---|---|---|
| and | | | | | |
| Comparative | Maximum | | B Coercive | I Coercive | Maximum Energy |
| Example | magnetization | Remanence | Force | Force | Product |
| No. | Jmax (T) | Br (T) | bHc (kA/m) | iHc (kA/m) | (BH)max (kJ/m³) |
| Example 10 | 1.0070 | 0.6474 | 404.2 | 946.1 | 67.02 |
| Example 11 | 0.9429 | 0.5919 | 345.4 | 782.9 | 53.61 |
| Example 12 | 1.0130 | 0.6396 | 382.2 | 854.9 | 63.38 |
| Example 13 | 1.0110 | 0.6535 | 423.8 | 1075.0 | 69.96 |
| Example 14 | 0.9682 | 0.6010 | 341.0 | 655.5 | 54.31 |
| Example 15 | 0.9923 | 0.6300 | 383.0 | 876.1 | 62.39 |
| Example 16 | 1.0110 | 0.6552 | 435.8 | 1074.0 | 71.81 |
| Example 17 | 1.0110 | 0.6491 | 408.3 | 964.5 | 67.78 |
| Example 18 | 1.0150 | 0.6563 | 421.3 | 1019.0 | 70.05 |
| Example 19 | 1.0180 | 0.6572 | 424.6 | 1010.0 | 70.62 |
| Example 20 | 0.7898 | 0.5088 | 344.3 | 954.6 | 43.74 |
| Example 21 | 0.8789 | 0.5708 | 387.8 | 997.6 | 55.58 |
| Example 22 | 0.9240 | 0.5997 | 398.4 | 954.3 | 60.35 |
| Comparative | 1.0460 | 0.6325 | 327.7 | 643.5 | 55.22 |
| Example 3 | | | | | |
| Comparative | 0.9284 | 0.5702 | 318.8 | 614.8 | 48.00 |
| Example 4 | | | | | |

TABLE 8

| Example and | Maximum | | B Coercive | I Coercive | Maximum Energy |
|---|---|---|---|---|---|
| Comparative | Magnetization | Remanence | Force | Force | Product |
| Example No. | Jmax (T) | Br (T) | bHc (kA/m) | iHc (kA/m) | (BH)max (kJ/m³) |
| Example 23 | 0.9352 | 0.5777 | 322.2 | 599.3 | 49.70 |
| Example 24 | 1.0000 | 0.6249 | 354.7 | 737.9 | 58.57 |
| Example 25 | 0.9787 | 0.5988 | 314.2 | 591.8 | 50.92 |
| Example 26 | 0.9067 | 0.5806 | 358.6 | 827.0 | 53.78 |
| Example 27 | 0.9142 | 0.5853 | 356.7 | 798.0 | 54.26 |
| Example 28 | 0.9890 | 0.6270 | 369.9 | 867.4 | 59.72 |
| Example 29 | 0.9800 | 0.6020 | 331.5 | 644.8 | 52.83 |
| Comparative | 0.7538 | 0.5451 | 241.5 | 395.3 | 36.07 |
| Example 5 | | | | | |

Magnetic properties at room temperature (22.5 to 22.6° C.), 100° C., and 150° C. of magnetic materials obtained in Example 30 and Comparative Example 6 were evaluated with BH tracer (manufactured by Tamakawa Co., Ltd.). The results are shown in Table 9.

TABLE 9

| Example and | Measurement | | B Coercive | I Coercive | |
|---|---|---|---|---|---|
| Comparative | Temperature | Remanence | Force | Force | Maximum Energy Product |
| Example No. | (° C.) | Br (T) | bHc (kA/m) | iHc (kA/m) | (BH)max (kJ/m³) |
| Example 30 | 22.5 | 1.0476 | 650.2 | 1051.5 | 182.27 |
| | 100.0 | 0.9340 | 421.2 | 565.3 | 124.56 |
| | 150.0 | 0.8565 | 281.8 | 353.2 | 81.89 |
| Comparative | 22.6 | 1.0190 | 379.1 | 511.5 | 121.50 |
| Example 6 | 100.0 | 0.8887 | 206.1 | 243.2 | 63.03 |
| | 150.1 | 0.7635 | 127.6 | 143.8 | 34.04 |

In tables, the higher the values of Jmax (maximum magnetization), Br (remanence), bHc (B coercive force), iHc (I coercive force), and (BH)max (maximum energy product), the more the magnetic properties are excellent.

### (Consideration)

### [Magnetic Material]

The maximum magnetization, remanence, coercive force (B coercive force, I coercive force), and maximum energy product were excellent in the magnetic materials of Examples, i.e., the magnetic materials obtained by mixing a magnet powder of neodymium-iron-boron magnet powder with an amorphous metal containing a rare-earth element, iron, and boron, and containing the rare-earth element in the range of 22 to 44 atomic %, and the boron in the range of 6 to 28 atomic %, and by heating the mixture to a temperature or more, the temperature being lower by 30° C. than the crystallization temperature (Tx) of the amorphous metal, or when the amorphous metal is a metallic glass, heating the mixture to a temperature of the glass transition temperature (Tg) thereof or more, compared with the magnetic material of Comparative Example 5 in which other magnet powder and amorphous metal were used.

### [Amorphous Metal]

The magnetic material of Comparative Example 1 not containing the amorphous metal had poor coercive force (B coercive force, I coercive force) and maximum energy product, compared with the magnetic materials of Examples 1 to 4 produced under the same conditions except for the fact that the amorphous metal was contained.

Similarly, the magnetic material of Comparative Example 3 which does not contain the amorphous metal had poor coercive force (B coercive force, I coercive force) and maximum energy product compared with the magnetic materials of Examples 10, and 20 to 22 produced in the same manner except for the fact that the amorphous metal was contained.

### [Heat Treatment Temperature]

The magnetic material of Comparative Example 2 which was heat-treated at a temperature lower than the glass transition temperature (Tg) of the amorphous metal had poor maximum magnetization, remanence, coercive force (B coercive force, I coercive force), and maximum energy product compared with the magnetic materials of Examples 3 and 6 produced in the same manner except for the fact that the heat treatment was conducted at a temperature of the glass transition temperature (Tg) of the amorphous metal or more.

Similarly, the magnetic material of Comparative Example 4 which was heat-treated at a temperature lower than the glass transition temperature (Tg) of the amorphous metal had poor maximum magnetization, remanence, coercive force (B coercive force, I coercive force), and maximum energy product compared with the magnetic materials of Examples 10, and 14 to 16 produced in the same manner except for the fact that the heat treatment was performed at the glass transition temperature (Tg) of the amorphous metal or more.

Furthermore, based on Examples 28 and 29, it was confirmed that a magnetic material having excellent magnetic properties can be produced by heat-treating at a temperature or more, the temperature being a temperature lower by 30° C. than the crystallization temperature (Tx) of the amorphous metal when the amorphous metal having no glass transition temperature (Tg) was used.

### [Magnetic Field Pressing]

The magnetic material of Example 30 in which the mixture of the magnetic anisotropic magnet powder and the amorphous metal was subjected to magnetic field pressing had excellent magnetic properties at room temperature compared with the magnetic material of Example 16 produced under the same conditions except for the fact that the magnetic field pressing was not conducted, and with the magnetic material of Comparative Example 6 produced under the same conditions except for the fact that the amorphous powder was not used.

Furthermore, it was confirmed that the magnetic material of Example 30 had excellent magnetic properties even under a high temperature environment such as 100° C., or 150° C.

While the illustrative embodiments of the present invention are provided in the above description, such is for illustrative purpose only and it is not to be construed as limiting the scope of the present invention. Modifications and variations of the present invention that will be obvious to those skilled in the art are to be covered by the following claims.

### INDUSTRIAL APPLICABILITY

The magnetic material of the present invention is suitably used, for example, in driving motors of hybrid automobiles and electric vehicles, and in motors embedded in various machinery and materials such as compressors of air conditioners.

1. A magnetic material in which a magnet powder and an amorphous metal are used as ingredients,
wherein the magnet powder is a neodymium-iron-boron magnet powder,
the amorphous metal contains a rare-earth element, iron, and boron,
the amorphous metal contains the rare-earth element in the range of 22 to 44 atomic %, and the boron in the range of 6 to 28 atomic %, and
the magnetic material is obtained by mixing the magnet powder and the amorphous metal, and heating the mixture to a temperature or more, the temperature being lower by 30° C. than the crystallization temperature (Tx) of the amorphous metal, or when the amorphous metal is a metallic glass, heating the mixture to a temperature of the glass transition temperature (Tg) thereof or more.

2. The magnetic material according to claim 1, wherein a magnetic anisotropic magnet powder is used as the magnet powder, and a mixture of the magnetic anisotropic magnet powder with the amorphous metal is subjected to magnetic field pressing.
